(19) United States
(12) Patent Application Publication
(10) Pub. No.: US 2024/0427151 A1
(43) Pub. Date: Dec. 26, 2024

(54) Angle Multiplexed Diffractive Combiner

(71) Applicant: ams International AG, Jona (CH)

(72) Inventors: Eric TREMBLAY, Eindhoven (NL); Carlos MACIAS, Eindhoven (NL)

(21) Appl. No.: 18/708,231

(22) PCT Filed: Oct. 17, 2022
(86) PCT No.: PCT/EP2022/078809

§ 371 Date: May 8, 2024

(30) Foreign Application Priority Data
Nov. 22, 2021 (GB) 2116770.5

(51) Int. Cl. G02B 27/01; G02B 27/00; G02B 27/10

(52) U.S. Cl. CPC G02B 27/0172; G02B 27/106; G02B 27/1086; G02B 27/0081; G02B 2027/0125; G02B 2027/0174; G02B 2027/0178

(57) ABSTRACT

An optical system for a wearable heads-up display includes an image projector configured to project an image towards an eye of a user and a combiner element positioned in a field of view of the user and in an optical path between the image projector and the eye of the user. The combiner element is configured to replicate the image onto a plurality of positions in a plane at the eye of the user. The combiner element includes a splitting element configured to split incident light into a plurality of directions and a first volume phase holographic (VPH) element. The first VPH element includes a plurality of multiplexed holograms, each hologram configured to selectively collimate incident light according to a respective angle of incidence on the first VPH element.

### RELATED APPLICATION(S)

This application is a US National Stage Application of International Application PCT/EP2022/078809, filed on 17 Oct. 2022, and claims priority under 35 U.S.C. § 119 (a) and 35 U.S.C. § 365 (b) from United Kingdom Patent Application GB 2116770.5, filed on 22 Nov. 2021, the contents of which are incorporated herein by reference in their entirety.

### FIELD

The present disclosure relates to an optical system for a wearable heads-up display, and to a wearable heads-up display comprising such an optical system.

### BACKGROUND

Off-axis retinal scanning displays (ORSDs) are a type of display that are used in virtual and augmented reality applications such as in wearable heads-up displays. They are designed to allow a user to see projected content in their field of view in a manner that allows the user to continue to see their external environment as well. ORSDs work by using a projector secured to a user's head to project an image onto the retina of the user which causes the user to see displayed content floating in space in front of them.

The projector is attached to the side of (i.e. off-axis to) a wearable frame, for example a headset or glasses frame with eye pieces. The eye pieces are provided with a holographic combiner which are illuminated by the projector. The illuminated holographic combiners cause the image to be projected through the user's pupil onto their retina.

As is known in the field, in near-eye optical devices such as ORSDs, the term “eyebox” refers to a volume of space relative to the ORSD in which the user has to position their eye to be able to correctly see the full, projected image. If an ORSD has a small eyebox, the range of eye positions at which the user can correctly see the full image is small. If an ORSD has a large eyebox, the range of eye positions at which the user can correctly see the full image is greater which thus provides a better user experience. If the user moves their eye position outside of the eyebox, they will see only part of the projected image or not see it at all. This is because it is only in the eyebox that the user's pupil and thus retina is correctly aligned with the optical path of the light projected by the ORSD. It is also known that the gaze direction of a user can effect whether or not the user's pupil lines up with the optical path of the light projected by the ORSD, particularly where the eyebox is small and only covers the eye position of a user gazing directly ahead.

A further problem is that users have different head shapes and sizes which means it is necessary to custom fit ORSDs individually to a user's head measurements to get the eyebox to line up with the eye of a given user—something which is inefficient to do at scale for mass production.

One way to overcome such issues is to actively steer the eyebox of the ORSD to overlap with the pupil of the eye of the user. For example by tracking the user's eye position and adapting the projection direction of the projector to match the user's eye position. However such systems are complex, may require motorised or actuated components and are therefore not practical.

An alternative approach is to use pupil replication. As is known in the field, the term “pupil” in pupil replication refers to copying the exit pupil of the optical system, that is, a copy of the full image being projected. Pupil replication works by replicating the full image a number of times and projecting each copy to a different position in front of the user's eye. As long as one of the replicated pupil's overlaps with the pupil of the user's eye, at least one copy of the image will be projected onto the user's retina and the user will be able to see the projected image correctly. This has the effect of increasing the size of the eyebox as the user's eye can be in any position where there is overlap with at least one replicated pupil. U.S. Pat. No. 10,031,338 B2 proposes a method for eyebox expansion by pupil replication in the projector. The projector then directs the replicated pupils onto a holographic combiner and then on to the user's eye.

However, known pupil replication approaches such as these only work when the replication typically occurs at an image plane (by diffusing the light and expanding etendue) or at the pupil (Fourier) plane where light is collimated (e.g. as is done in waveguide type approaches). In these cases, the replications can be collected and presented to the eye by a single optical function. For example, a single lens function if expanded at an image plane, or by a single grating function if replicated when the light is collimated (e.g. waveguide approaches).

This limitation has a major drawback in that it limits design flexibility of where the replication optical elements may be positioned. For example, in U.S. Pat. No. 10,031,338, pupil replication occurs in or at the projector using a bulky prism, which is impractical and limits the size of the replicated pupil that can be achieved, that is, it limits the pupil expansion that is possible.

There is a need for an optical system for a wearable heads-up display that is less bulky and has greater design flexibility in terms of positioning of the optical elements.

### SUMMARY

In general terms, in the present disclosure it is appreciated that the above described requirement that pupil replication must occur at an image or pupil (Fourier) plane can be overcome and that replication at a position in the optical path away from these two planes is possible provided that individual (i.e. selective) optical functions are applied to individual replicated beams. Various embodiments of the present disclosure describe achieving this by using a splitting element (for example a diffractive splitting element) positioned away from the image and Fourier planes to replicate the initially projected beam and subsequently using angle multiplexing in a volume phase holographic (VPH) element to collect and collimate the replicated beams with the correct angles to direct them towards a user's eye. This is possible because the plurality of multiplexed holograms of the VPH element apply a different optical function to each individual replicated beam according to its angle of incidence on the VPH element.

This allows for a much greater degree of design flexibility in terms of where the optical elements may be positioned. For example, this allows both the splitting element and the collimating element to be provided close together on/at the holographic combiner of a display for example on an eyepiece of the display and without the need for a splitting element to be provided in the projector or elsewhere on the display. Thus, the system of the present disclosure may be thinner, smaller and have a larger eyebox than known off-axis retinal displays.

Thus, according to a first aspect, there is provided an optical system for a wearable heads-up display, the optical system comprising: an image projector configured to project an image towards an eye of a user; and a combiner element positioned in a field of view of the user and in an optical path between the image projector and the eye of the user, the combiner element being configured to replicate the image onto a plurality of positions in a plane at the eye of the user, the combiner element comprising: a splitting element configured to split incident light into a plurality of directions, and a first volume phase holographic (VPH) element comprising a plurality of multiplexed holograms, each hologram configured to selectively collimate incident light according to a respective angle of incidence on the first VPH element.

As described above, the use of a VPH element to collimate incident light split by a splitting element and to direct it towards the plurality of positions in the plane at the eye of the user expands the eyebox of the display while providing much greater design flexibility than known displays because the splitting element may be positioned anywhere in the optical path and not just in the image or pupil plane. This allows for a much more compact and simpler arrangement compared to known displays.

In some implementations, the splitting element comprises a second VPH element.

VPH elements have very high efficiencies and low losses for light propagating through them. Thus, synergistically, when the splitting element is also a VPH element, the optical system has a significantly greater optical efficiency than systems that use other, non-VPH optical components as splitting elements.

In some implementations, the splitting element is positioned in the optical path spaced apart from an image plane of the image projector.

As described above, this is made possible because of the use of the first VPH element to allow placement of the splitting element anywhere in the optical path, including for example at or on a surface of an eyepiece of the display, rather than on or at a projector or elsewhere on a heads up display.

In some implementations, the splitting element is a reflective optical element and wherein the first VPH element is a transmissive optical element. For example, in this arrangement, the image projector is arranged to (i) project light through the first VPH element on a first pass, (ii) reflect light from the splitting element, and (iii) project light through the first VPH element on a second pass after reflection from the splitting element, whereby the first VPH element is configured to selectively collimate said incident light on the second pass. An angle of incidence of light on the first VPH element on the first pass is greater than a critical angle of the first VPH element allowing said light to propagate through the first VPH element on the first pass without being collimated by said first VPH element.

This arrangement can allow the projector to be positioned off-axis on the heads up display relative to the combiner element as the initially projected image passes through the first VPH element on the first pass without interacting with it because it is outside a critical angle of the first VPH element. The light instead interacts first with the splitting element (e.g. a single-off-axis-point-to-many-plane-wave reflection VPH element) that functions as a pupil splitter not located at an image plane nor a pupil plane) which splits it into multiple directions in two dimensions (e.g. directions in a 2D rectangular or hexagonal arrangement of angles). The split light beams then pass through the first VPH element for the second pass where they now do interact with it as the angle is not outside the critical angle. The first VPH element may be angle-and-shift multiplexed such that each of the many plane waves generated by the splitting element are diffracted to a corresponding exit pupil point near or at the user's eye location. The first VPH element thus functions as a many-plane-to-many-points multiplexed transmission VPH element and as a selective collimator for each of the diffractions (i.e. split beams) of the splitting element. The term “selective” herein means that each multiplexed hologram acts on one of the diffraction angles produced by the splitting element.

Alternatively, in some implementations, the splitting element is a transmissive optical element and the first VPH element is a reflective optical element. For example, the image projector is arranged to (i) project light through the splitting element on a first pass, (ii) reflect light from the first VPH element, and (iii) project light through the splitting element on a second pass after reflection from the first VPH element, whereby the splitting element is configured to split said light into said plurality of directions on the first pass. An angle of incidence of light on the splitting element on the second pass is greater than a critical angle of the splitting element allowing said light to propagate through the splitting element on the second pass without being split into said plurality of directions.

This arrangement again allows the projector to be positioned off-axis on the heads up display relative to the combiner element as the initially projected image passes through the splitting element on the second pass without interacting with it.

In some implementations, the splitting element is configured to split said incident light into a plurality of directions having acute angles relative to the angle of incidence of said incident light onto the splitting element. For example, the holograms are configured to split the incident light when it is coming from the angle of the projector on the first pass but not the angle when reflected from the (reflective) VPH collimator on the second pass.

This helps to avoid cross-talk interactions on of the light through the splitting element on the second pass where it should not interact with the splitting element.

In some implementations, the splitting element comprises a polarising Bragg diffraction grating. Optionally, the image projector is configured to project the image using light of a first polarisation and wherein the polarising Bragg diffraction grating when diffracting said light of the first polarisation is configured to change the first polarisation to a second polarisation.

In this arrangement, crosstalk may be avoided by using polarisation control. That is, the light incident on the splitting element has one polarization whereas light exiting the splitting element has a different polarisation allowing filters to be used to filter out any light that does not have the desired polarisation, ensuring only the split light continues to propagate.

In some implementations, both the Bragg diffraction grating and the first VPH element are transmissive optical elements and wherein the system comprises a reflective element positioned in the optical path after the Bragg diffraction grating to allow said incident light to pass through the Bragg diffraction grating twice.

This double pass allows the splitting element (i.e. the Bragg diffraction grating) to be thinner than if the light passed through it only once because the light interacts in both directions with the Bragg diffraction grating, thus achieving the desired diffraction with half the material thickness.

In some implementations, the splitting element comprises a surface relief diffraction grating.

In some implementations, the image projector comprises a scanning laser projector.

In some implementations, the optical system comprises an actuator configured to move one of the splitting element or first VPH element relative to the other. For example, the actuator may comprise a mechanical motor that displaces or rotates one or both of the splitting element or first VPH element, or an electrically addressable grating configured to change the angle at which light is emerges from the respective elements. This has the effect of changing the optical path between the splitting element and the first VPH element depending on the user's vergence which may be tracked for example using known eye or gaze-tracking software and hardware methods.

This implementation allows for vergence-accommodation conflict and the discomfort it causes to some users to be addressed using hardware instead of using UI design or other presentational or software methods (for example using long viewing distances, matching simulated distance in the display and focal distance as best as possible, moving objects in and out of depth at a slow pace, maximising other depth cues for the user, avoiding the stacking of smaller objects at widely varying depths in the scene, and others). Thus, user discomfort caused by vergence-accommodation conflict is significantly reduced and the user experience is greatly improved in a reliable and efficient manner regardless of UI design. In turn, a much greater freedom and flexibility in app or UI design is provided as the above described approaches to minimise the discomfort caused by vergence accommodation conflict no longer need to be deployed.

According to a second aspect of the disclosure, there is provided a wearable heads-up display comprising the optical system described above, and a support frame for mounting the optical system thereon. The support frame may be for example, an eyeglass frame.

Optionally, the wearable heads-up display may comprise at least one eye piece, wherein the splitting element is positioned on a first surface of the at least one eye piece, and wherein first VPH element is positioned on a second surface of the at least eye piece opposite the first surface. In some implementations, the wearable heads-up display comprises an off-axis retinal scanning display.

As described above, this arrangement means the splitting element can be positioned no further apart from the VPH element than the thickness of the eyepiece and can thus be provided on the eyepiece to provide a significantly more compact arrangement than known systems.

### BRIEF DESCRIPTION OF THE DRAWINGS

These and other aspects will now be further described, by way of example only, with reference to the accompanying figures in which:

FIG. 1 illustratively shows a wearable heads-up display according to the present disclosure.

FIG. 2a illustratively shows an optical system for a wearable heads-up display according to the present disclosure.

FIG. 2b illustratively shows an optical system for a wearable heads-up display according to the present disclosure.

FIG. 3 illustratively shows an optical system for a wearable heads-up display according to the present disclosure.

FIG. 4 illustratively shows a simplified optical system for a wearable heads-up display according to the present disclosure.

FIG. 5a illustratively shows an optical system for a wearable heads-up display according to the present disclosure.

FIG. 5b illustratively shows an optical system for a wearable heads-up display according to the present disclosure.

FIG. 6 illustratively shows a simplified optical system for a wearable heads-up display according to the present disclosure.

FIG. 7 illustratively shows an optical system for a wearable heads-up display according to the present disclosure.

### DETAILED DESCRIPTION OF THE DRAWINGS

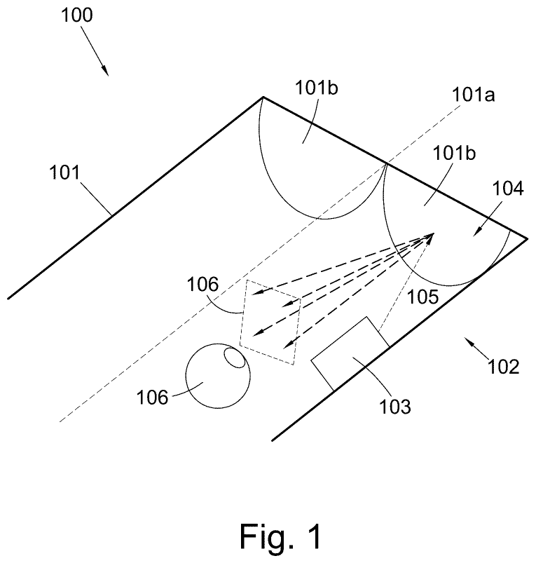

FIG. 1 illustratively shows a wearable heads-up display 100 according to the present disclosure. The wearable heads-up display 100 is an off-axis retinal scanning display comprising a support frame 101 with a central axis 101a and a pair of eyepieces 101b. An optical system 102 is mounted on the support frame 101. The optical system 102 comprises an image projector 103, such as a scanning laser projector and a combiner element 104, for example as one of the eyepieces 101b or arranged on or both of the surfaces or in one of the eyepieces 101b. The projector 103 is offset from the central axis 101a and configured to project an image 105 towards an eye 106 of a user by way of the combiner element 104. The combiner element 104 is positioned in the field of view of the user (i.e. in the field of view of the user's eye) and is configured to replicate the projected image a number of times onto a plurality of positions in a plane 107 at the eye 106 of the user to expand the eyebox of the wearable heads-up display 100.

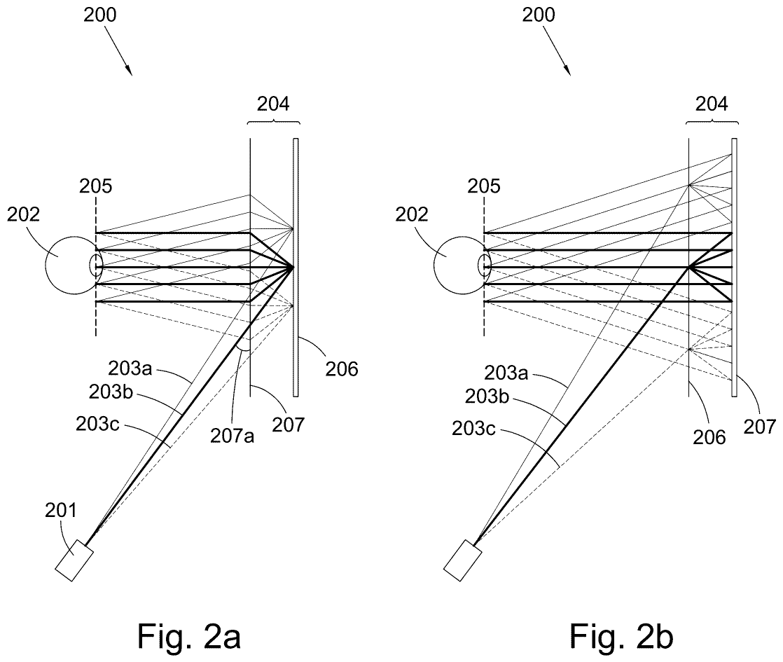

FIG. 2a illustratively shows an optical system 200 for a wearable heads-up display according to the present disclosure. The optical system 200 comprises an image projector 201 for projecting an image towards an eye 202 of a user. The projector 201 may comprise a MEMS projector and a projection lens that function as an entrance pupil to the optical system. The projector 201 may be configured to project in RGB colours and combinations thereof. FIG. 2a shows only the chief rays 203a, 203b, 203c projected by the projector 201 even though it will be appreciated that other rays are present.

The optical system 200 further comprises a combiner element 204 positioned in a field of view of the user and in an optical path between the image projector 201 and the eye 202 of the user. The combiner element 204 is configured to replicate the image projected by the image projector 201 onto a plurality of positions to create replicated images (i.e. exit pupils) at each of those positions in a plane 205 at the eye 202 of the user. As described above, this has the effect of expanding the size of the eyebox of the display as the user may now position his eye anywhere where his pupil overlaps with one of the replicated images (i.e. exit pupils) of the display.

The combiner element 204 comprises a splitting element 206 and a first volume phase holographic (VPH) element 207. The splitting element 206 in the example of FIG. 2a is a reflective VPH element that functions as a one-to-many splitter. The VPH element 207 is a transmissive VPH element that functions as a multiplexed collimator and comprises a plurality of holograms configured to selectively collimate incident light according to a respective angle of incidence on the first VPH element 207. That is, the plurality of holograms provide individual (i.e. selective) optical functions that get applied to individual, replicated beams passing through it depending on the angle of incidence. In other words, the first VPH element 207 applies a different optical function to each individual, replicated beam according to its angle of incidence on the first VPH element 207.

The path the light takes through the optical system will now be described. The light 203a, 203b, 203c from the projector 201 propagates through the first VPH element 207 first without interacting with it to reach the splitting element 206. Interaction is avoided by ensuring that the angle of incidence 207a onto the first VPH element 207 is greater than a critical angle of the first VPH element 207 i.e. an angle under which the VPH element 207 would begin to have an effect. The light 203a, 203b, 203c upon reaching the splitting element 206 is reflected and split into a plurality of directions, back in the general direction of the eye 202 of the user. The split light, now incident on the first VPH element 207 from an angle at which interaction will occur, is selectively collimated by the first VPH element 207 (i.e. a different optical function is applied to each ray depending on the angle of incidence) and thereby redirected towards said plurality of positions in the plane 205 to form the replicated images in the plane 205 at the user's eye to expand the eyebox of the display. As the collimation of each ray depends on its angle of incidence on the first VPH element 207 neither the splitter element 206 nor the first VPH element 207 that functions as a collimator need to be placed at in image or pupil (Fourier) plane of the projector 201, thereby providing the ability to position both elements significantly closer together than in known systems. For example, they may be placed as close to each other as the thickness of an eyepiece of the wearable heads-up display in which they are used, which means neither components takes up space in the projector or elsewhere on or in the wearable heads-up display.

FIG. 2b illustratively shows an optical system for a wearable heads-up display according to the present disclosure. Like-numbered numerals refer to like-numbered elements. The arrangement is the same as the arrangement of FIG. 2a except that the splitting element is now a transmissive element and the first VPH element is a reflective element and they are arranged the other way around so that the light 203a, 203b, 203c from the projector reaches the splitting element 206 first and also interacts and is thus split on the first pass through it whereas now it does not interact on its second pass through the splitting element.

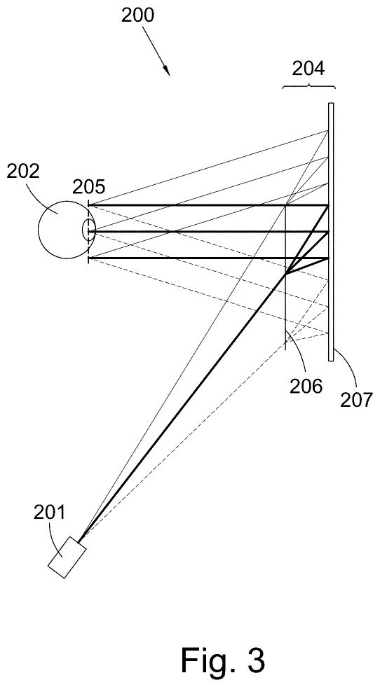

FIG. 3 illustratively shows an optical system according to the present disclosure. Like-numbered numerals refer to like-numbered elements. FIG. 3 illustrates a features that the arrangement of FIG. 2b enables, namely it allows a tilt bias on the internal angles to be introduced. That is, the splitting element splits the light beams in directions that are more tilted relative to the surface of the VPH element that collimates the beams than in FIG. 2b. This results in a bigger difference in angles between the split light beams and the collimated beams and also allows the splitting element to be positioned partially or fully out of the way of the collimated beams coming from the VPH element. The effect of this is to significantly reduce crosstalk, thereby reducing image artefacts and noise when the user looks at the projected image. Another way to say this is that the plurality of directions the splitting element splits the light into have acute angles relative to the angle of incidence of the light incident on the splitting element.

Whilst FIG. 3 shows the It is envisaged that the tilt can be in either direction. One way to achieve this is, for example by positioning the projector 201 on an opposite side of the frame to the eyepiece onto which the image is being projected whereby the image is projected from a projector on one side of the frame the user is wearing, across the face of the user to the eyepiece of the other side. This allows a significantly greater tilt angle to be achieved than is possible when positioning the projector on the same side of the frame as the eyepiece on which the image is being projected. As a result, this arrangement allows cross talk to be more strongly reduced. As described above, one way in which ross talk is reduced is because the effect the hologram has on incident light is angle dependent, that is, only light having predetermined angles will be split or collimated in the predetermined directions. The increased tilt angle ensures there is a greater difference between (i) incident angles where it is desired for the hologram to have an effect the incident light and (ii) any incident angles where it is not desired for the hologram to have an effect on the incident light.

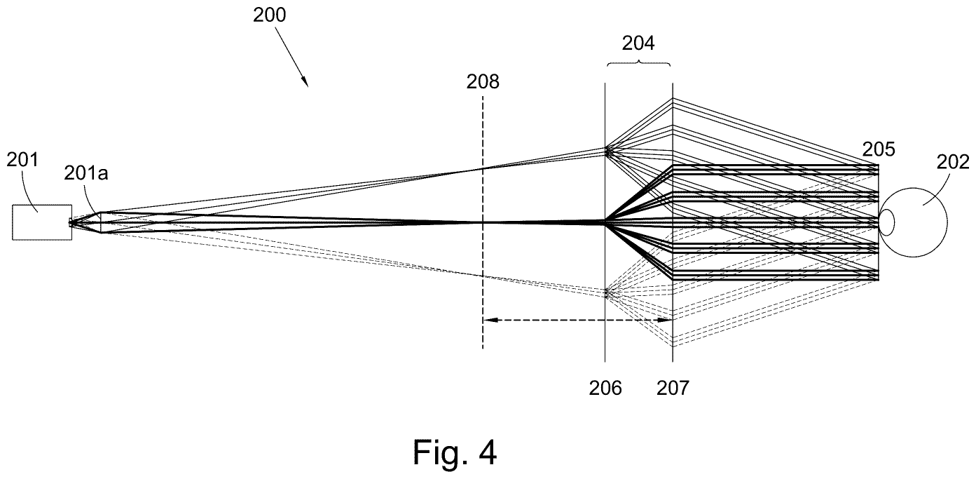

FIG. 4 illustratively shows a simplified optical system according to the present disclosure to illustrate the propagation of rays other than the chief rays. Like-numbered reference numerals refer to like-numbered elements. The simplified illustration shows all the components in-line with each other even though it is envisaged the system in practice will still be an off-axis system of the type shown in FIG. 1. As described above, the projector 201 may comprise a MEMS projector and an optional a projection lens 201a that function as an entrance pupil to the optical system. FIG. 4 illustrates that an intermediate focal plane 208 exists at a position in the optical path where the projected image will be in focus. This plane 208 is an example position where known systems would have to position their combiner element (e.g. the splitting element and/or a collimating element). If the typical optical path of an ORSD is considered this position would result in bulky optics being positioned either on the frame or in/at the projector resulting in a bulky display. In contrast, as can be seen in FIG. 4, the use of a VPH element to collimate the split light according to angle of incidence allows both the splitting element and VPH element to be positioned in the optical path spaced apart from this focal plane, which may be, for example, an image or focal plane of the image projector. As described above, this provides for a significantly more compact design with much greater design flexibility in terms of positioning optical elements than in known systems.

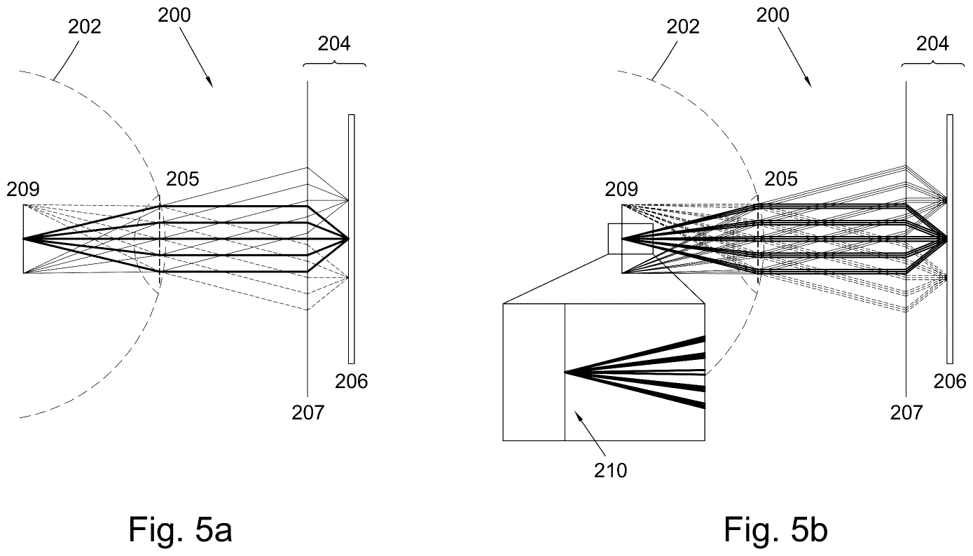

FIGS. 5a and 5b illustratively show an optical system for a wearable heads-up display according to the present disclosure to illustrate the behaviour of the replicated chief rays and non-chief rays entering the user's eye through their pupil. Like-numbered reference numerals refer to like-numbered elements. A 20 mm scale is shown for illustrative purposes only and the present disclosure is not limited to the size indicated by the 20 mm scale. As is shown in FIG. 5a, the chief rays are stigmatic (i.e. do not exhibit aberrations) in either the image plane where the retina is positioned at approximately 17 mm from the paraxial lens of the eye or in the pupil plane i.e. where the exit pupils are replicated.

FIG. 5b in contrast illustrates that the non-chief rays do exhibit different aberrations (such as focus aberrations and astigmatism aberrations) as can be seen from the zoomed in view 209a of the plane of the user's retina. As the plurality of holograms of the VPH element can be customised to apply a unique optical function to each individual ray, the VPH element (either as the collimating element and/or as the splitting element) can be customised to provide freeform VPH functions to compensate for such aberrations. This provides a synergistic effect in that not only does the VPH element provide for a much more compact arrangement for the reasons given above, but also allows for aberrations to be compensated for by appropriate design of the holograms of the VPH element to apply aberration reducing VPH optical functions to the light propagating through it based on incident angle.

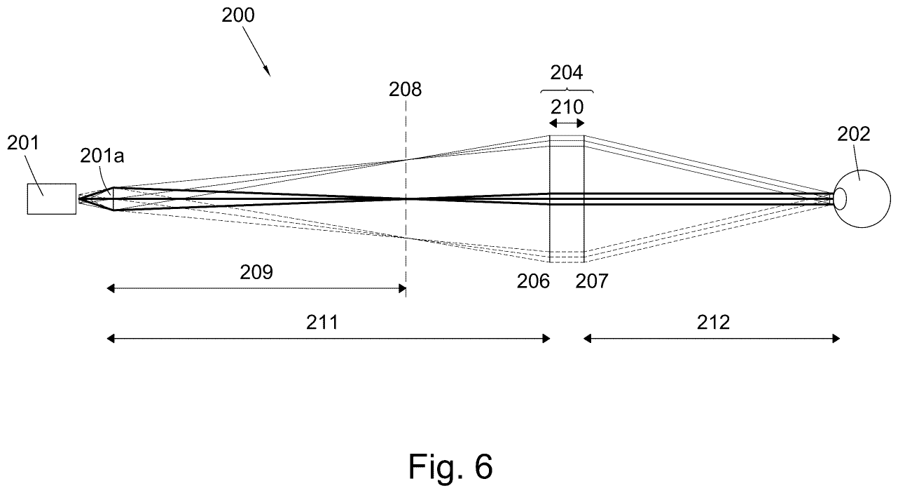

FIG. 6 illustratively shows a simplified optical system according to the present disclosure to illustrate the 1^{st} order optical parameters of the system. Like-numbered reference numerals refer to like-numbered elements. The simplified illustration shows all the components in-line with each other even though it is envisaged the system in practice will still be an off-axis system of the type shown in FIG. 1. As described above, the projector 201 may comprise a MEMS projector and an optional a projection lens 201a that function as an entrance pupil to the optical system. FIG. 6 illustrates that an intermediate focal plane 208 corresponding to the focal length 209 of the projection lens 201a of the projector 201 exists at a position in the optical path where the projected image will be in focus. This plane 208 is an example position where known systems would have to position their combiner element (e.g. the splitting element and/or a collimating element). If the typical optical path of an ORSD is considered this position would result in bulky optics being positioned either on the frame or in/at the projector resulting in a bulky display. In contrast, as can be seen in FIG. 6, the use of a VPH element 207 to collimate the split light according to angle of incidence allows both the splitting element 206 and VPH element 207 to be positioned in the optical path spaced apart from this focal plane 208. FIG. 6 also illustrates that the splitting element 206 and VPH element 207 may positioned as close to each other as the thickness 210 of an eyepiece of the wearable heads up display, for example by positioning one element on a front surface and one element on a back surface of the eyepiece. As described above, this provides for a significantly more compact design with much greater design flexibility in terms of positioning optical elements than in known systems. FIG. 6 also illustrates that, for the chief rays, the focal length 211 of the splitting element 206 corresponds to the distance from the entrance pupil (e.g. from the projection lens 201a of the projector 201) to the splitting element 206. Similarly, the focal length 212 of the VPH element 207 corresponds to the eye relief distance i.e. the distance from the pupil of the eye 202 to the VPH element 207.

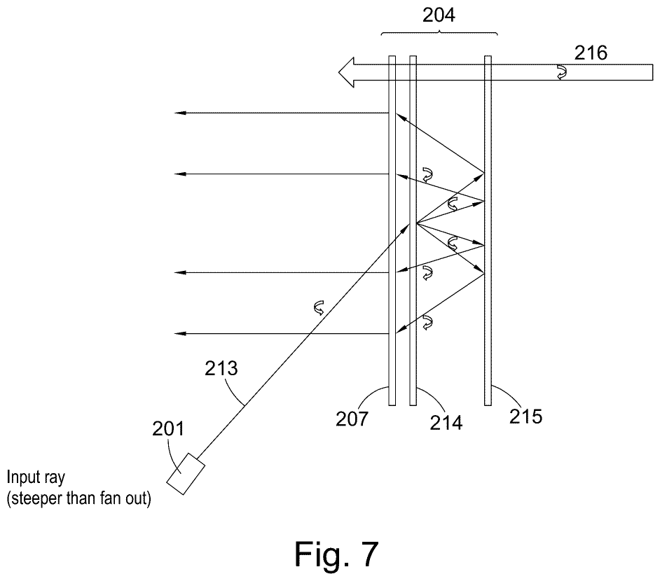

FIG. 7 illustratively shows an optical system according to the present disclosure. Like-numbered reference numerals refer to like-numbered elements. As with the optical systems described above, an image projector 201 is provided to project 213 an image towards an eye of a user using the combiner element 204. The arrangement is similar to the arrangement of FIG. 2a in that the initially projected light propagates on a first pass through the first VPH element 207 without interacting with it due to the incident angle being greater than a critical angle of the first VPH element. However unlike in the examples described above where the splitting element comprises a VPH element, the splitting element in the example of FIG. 7 comprises a polarising volume Bragg grating (PVG) 214 and a reflective element 215, for example a dichroic (RGB) mirror, positioned behind the PVG. In such an arrangement the PVG is envisaged to be a transmissive element.

The light 213 from the projector 201 is split by passing twice through the PVG material (reflecting off the reflective element after the first pass) which means the PVG may be half the thickness it would have needed to be had it only passed through the PVG once. This results in a splitting element that is thinner than in the examples described above in FIGS. 1-6 thereby providing the ability to produce an even more compact combiner element 204 for a given eyebox expansion size compared to using VPH elements for both the splitting element and collimator.

Further, the projector 201 may be configured to project light in one polarisation which is rotated upon reflection from the reflective element 215 so that the light that the user ultimately sees has a different (for example orthogonal) polarisation to the light that the projector initially projects. This reduces crosstalk and image artefacts as polarising filters may be used to filter out unwanted polarisations so that the user sees only the light with the correct polarisation from the combiner element 204. FIG. 7 also illustrates that light from the user's surrounding environment which passes through the eyepiece would still reach the user's eye as long as it has the same polarisation as the replicated and collimated beams. The arrangement in FIG. 7 also allows the initial rays projected by the projector 201 to have a steeper angle than in the examples of FIGS. 1-6.

Other effective alternatives will occur to the skilled person. It will be understood that the present disclosure is not limited to the described embodiments and encompasses modifications apparent to those skilled in the art lying within the scope of the claims appended hereto.

For example, whilst FIG. 3 is described with reference FIG. 2b whereby a tilt bias on the internal angles is introduced with a transmissive splitting element and reflective collimating element, the teaching of FIG. 3 may equally be applied to the arrangement of FIG. 2a. Specifically, the tilt bias may equally be introduced to the arrangement of FIG. 2a whereby a tilt bias on the internal angles may be introduced with a reflective splitting element and a transmissive collimating element arranged as shown in, for example, FIG. 2a. Thus, it is envisaged the tilt bias may be achieved with various configurations of relative positioning of the splitting element 206 and collimating element 207 in both transmissive and reflective setups. For example, at least six different configurations are envisaged: (i) splitting element 206 as a transmissive element may be arranged such that the incident light at obtuse angles relative to the surface of the element, (ii) splitting element 206 as a transmissive element may be arranged such that the incident light is at acute angles relative to the surface of the element, (iii) collimating element 207 as a reflective element may be arranged such that the incident light is at acute angles relative to the surface of the element, (iv) collimating element 207 as a reflective element may be arranged such that the incident light is at obtuse angles relative to the surface of the element, (v) combinations of the above arrangements in that element 206 is provided with incident light variously at both obtuse and acute angles, and (iv) combinations of the above arrangements in that element 207 is provided with incident light variously at both obtuse and acute angles.

### LIST OF REFERENCE NUMERALS

100 wearable heads-up display
101 support frame
101a central axis
101b pair of eyepieces
102 optical system
103 image projector
104 combiner element
105 projected image
106 user eye
107 plane at user eye
200 optical system
201 projector
201a projection lens
202 user eye
203a chief ray
203b chief ray
203c chief ray
204 combiner element
205 plane at user eye
206 splitting element
207 first VPH element
207a angle of incidence
208 intermediate focal plane
209 focal length of projection lens
209a zoomed view
210 eyepiece thickness
211 focal length of splitting element
212 focal length of first VPH element
213 chief ray
214 polarising Bragg diffraction grating
215 reflective element

What is claimed is:

1. An optical system for a wearable heads-up display, the optical system comprising:
an image projector configured to project an image towards an eye of a user; and
a combiner element positioned in a field of view of the user and in an optical path between the image projector and the eye of the user, the combiner element being configured to replicate the image onto a plurality of positions in a plane at the eye of the user, the combiner element comprising:
a splitting element configured to split incident light into a plurality of directions, and
a first volume phase holographic (VPH) element comprising a plurality of multiplexed holograms, each hologram configured to selectively collimate incident light according to a respective angle of incidence on the first VPH element.

2. The optical system according to claim 1, wherein the splitting element comprises a second VPH element.

3. The optical system according to claim 2, wherein the splitting element is positioned in the optical path spaced apart from an image plane of the image projector.

4. The optical system according to claim 1, wherein the splitting element is a reflective optical element and wherein the first VPH element is a transmissive optical element.

5. The optical system according to claim 4 wherein the image projector is arranged to (i) project light through the first VPH element on a first pass, (ii) reflect light from the splitting element, and (iii) project light through the first VPH element on a second pass after reflection from the splitting element, whereby the first VPH element is configured to selectively collimate said incident light on the second pass.

6. The optical system according to claim 5, wherein an angle of incidence of light on the first VPH element on the first pass is greater than a critical angle of the first VPH element allowing said light to propagate through the first VPH element on the first pass without being collimated by said first VPH element.

7. The optical system according to claim 1, wherein the splitting element is a transmissive optical element and the first VPH element is a reflective optical element.

8. The optical system according to claim 7, wherein the image projector is arranged to (i) project light through the splitting element on a first pass, (ii) reflect light from the first VPH element, and (iii) project light through the splitting element on a second pass after reflection from the first VPH element, whereby the splitting element is configured to split said light into said plurality of directions on the first pass.

9. The optical system according to claim 8, wherein an angle of incidence of light on the splitting element on the second pass is greater than a critical angle of the splitting element allowing said light to propagate through the splitting element on the second pass without being split into said plurality of directions.

10. The optical system according to claim 8, wherein the splitting element is configured to split said incident light into a plurality of directions having acute angles relative to the angle of incidence of said incident light onto the splitting element.

11. The optical system according to claim 1, wherein the splitting element comprises a polarising Bragg diffraction grating.

12. The optical system according to claim 11, wherein the image projector is configured to project the image using light of a first polarisation and wherein the polarising Bragg diffraction grating when diffracting said light of the first polarisation is configured to change the first polarisation to a second polarisation.

13. The optical system according to claim 12, wherein both the splitting element and the first VPH element are transmissive optical elements and wherein the system comprises a reflective element positioned in the optical path after the first VPH element to allow said incident light to pass through the first VPH element twice.

14. The optical system according to claim 1, wherein the splitting element comprises a surface relief diffraction grating.

15. The optical system according to claim 1, wherein the image projector comprises a scanning laser projector.

16. The optical system according to claim 1, further comprising:
an actuator configured to move one of the splitting element or first VPH element relative to the other.

17. A wearable heads-up display comprising:
the optical system of claim 1;
a support frame for mounting the optical system.

18. The wearable heads-up display according to claim 17, further comprising at least one eye piece,
wherein the splitting element is positioned on a first surface of the at least one eye piece, and
wherein first VPH element is positioned on a second surface of the at least eye piece opposite the first surface.

19. The wearable heads-up display according to claim 17, wherein the display comprises an off-axis retinal scanning display.
